(19) United States
(12) Patent Application Publication
(10) Pub. No.: US 2025/0297383 A1
(43) Pub. Date: Sep. 25, 2025

(54) ELECTROCHEMICAL CELL

(71) Applicant: NGK INSULATORS, LTD., Nagoya-shi (JP)

(72) Inventors: Genta TERAZAWA, Nagoya-shi (JP); Toshiyuki NAKAMURA, Handa-shi (JP); Takashi SHIRATORI, Nagoya-shi (JP); Makoto OHMORI, Nagoya-shi (JP)

(21) Appl. No.: 18/905,504

(22) Filed: Oct. 3, 2024

Related U.S. Application Data
(63) Continuation of application No. PCT/JP2024/010741, filed on Mar. 19, 2024.

(51) Int. Cl. C25B 11/032; C25B 9/19

(52) U.S. Cl. CPC C25B 11/032; C25B 9/19

(57) ABSTRACT

An electrochemical cell includes a metal support having a plurality of connecting holes formed in a principal surface and a cell body disposed on the principal surface. The cell body has a gas diffusion layer disposed on the principal surface, a first electrode layer disposed on the gas diffusion layer, a second electrode layer and an electrolyte layer disposed between the first electrode layer and the second electrode layer. The gas diffusion layer has a body portion located in a gap between the metal support and the first electrode layer and a protruding portion protruding from the body portion to the connecting holes. The protruding portion covers a portion of an inner circumferential surface of the connecting hole.

### CROSS-REFERENCE TO RELATED APPLICATION

This is a continuation of PCT/JP2024/010741 filed Mar. 19, 2024 the entire contents of which are hereby incorporated by reference.

### TECHNICAL FIELD

The present invention relates to an electrochemical cell.

### BACKGROUND ART

JP 2020-079189A discloses an electrochemical cell (an electrolytic cell, a fuel cell, etc.) with a cell body disposed on a metal support. The metal support has a plurality of connecting holes formed in a principal surface. The cell body has a gas diffusion layer formed on the principal surface of the metal support, a first electrode layer disposed on the gas diffusion layer, a second electrode layer, and an electrolyte layer disposed between the first electrode layer and the second electrode layer.

JP 2020-079189A states that through holes that are continuous with the connecting holes are formed in the gas diffusion layer in order to make it smooth to supply a gas from the connecting holes of the metal support to the first electrode layer and discharge a gas from the first electrode layer to the connecting holes.

### SUMMARY

However, in the electrochemical cell disclosed in JP 2020-079189A, the gas diffusion layer may be damaged (may become cracked or peel away) due to the vicinities of the connecting holes of the metal support being distorted.

An object of the present invention is to provide an electrochemical cell capable of preventing damage to the gas diffusion layer.

An electrochemical cell according to a first aspect of the present invention includes a metal support having a plurality of connecting holes formed in a principal surface and a cell body disposed on the principal surface. The cell body has a gas diffusion layer disposed on the principal surface, a first electrode layer disposed on the gas diffusion layer, a second electrode layer and an electrolyte layer disposed between the first electrode layer and the second electrode layer. The gas diffusion layer has a body portion located in a gap between the metal support and the first electrode layer and a protruding portion protruding from the body portion to the connecting holes. The protruding portion covers a portion of an inner circumferential surface of the connecting hole.

An electrochemical cell according to a second aspect of the present invention is the electrochemical cell according to the first aspect, the protruding portion tapers toward a side away from the body portion in a thickness direction.

An electrochemical cell according to a third aspect of the present invention is the electrochemical cell according to the first or second aspect, the protruding portion covers a portion of a metal support-side surface of the first electrode layer.

An electrochemical cell according to a fourth aspect of the present invention is the electrochemical cell according to the third aspect, the protruding portion tapers toward a side away from the body portion in a surface direction perpendicular to a thickness direction.

An electrochemical cell according to a fifth aspect of the present invention is the electrochemical cell according to the third or fourth aspect, the protruding portion has an exposed surface exposed to the connecting hole and the through hole, and the exposed surface is curved.

An electrochemical cell according to a sixth aspect of the present invention is the electrochemical cell according to any one of the first to fifth aspects, a ratio of a covering width in a thickness direction of a region of the inner circumferential surface of the connecting hole covered by the protruding portion to a thickness in the thickness direction of the body portion is 10 or more.

An electrochemical cell according to a seventh aspect of the present invention is the electrochemical cell according to any one of the first to sixth aspects, a covering width in a thickness direction of a region of the inner circumferential surface of the connecting hole covered by the protruding portion is 10 μm or more.

An electrochemical cell according to an eighth aspect of the present invention is the electrochemical cell according to any one of the first to seventh aspects, the metal support has a substrate and an oxide film covering a surface of the substrate, and a first portion of the oxide film exposed to the connecting holes is thicker than a second portion of the oxide film covered by the protruding portion.

An electrochemical cell according to a ninth aspect of the present invention is the electrochemical cell of any one of the first to eighth aspects, an average pore diameter of multiple pores of the gas diffusion layer is smaller than an average pore diameter of multiple pores of the first electrode layer.

An electrochemical cell according to a tenth aspect of the present invention is the electrochemical cell of the ninth aspect, a porosity of the gas diffusion layer is larger than a porosity of the first electrode layer.

With the present invention, it is possible to provide an electrochemical cell capable of preventing damage to the gas diffusion layer.

### BRIEF DESCRIPTION OF DRAWINGS

FIG. 1 is a plan view of an electrolytic cell according to an embodiment.

FIG. 2 is a cross-sectional view taken along line A-A in FIG. 1.

FIG. 3 is a partially enlarged view of FIG. 2.

FIG. 4 is a cross-sectional view showing a variation of a connecting hole.

FIG. 5 is a cross-sectional view showing a variation of the connecting hole.

### DESCRIPTION OF EMBODIMENTS

### Electrolytic Cell 1

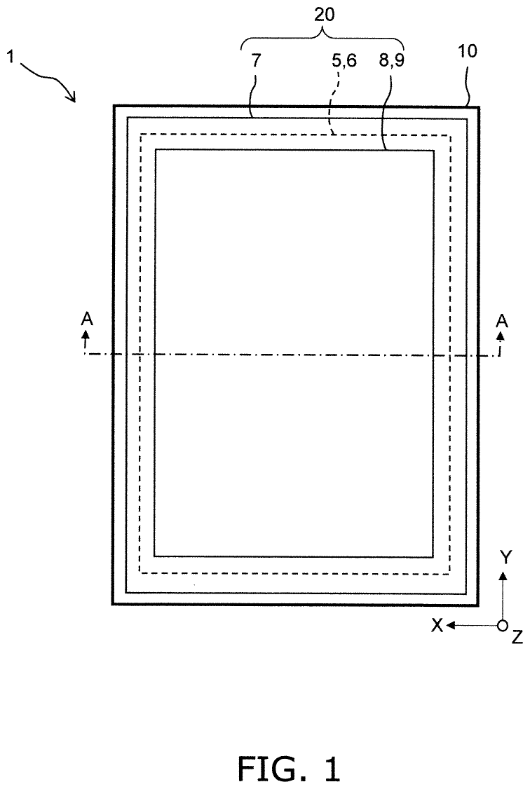

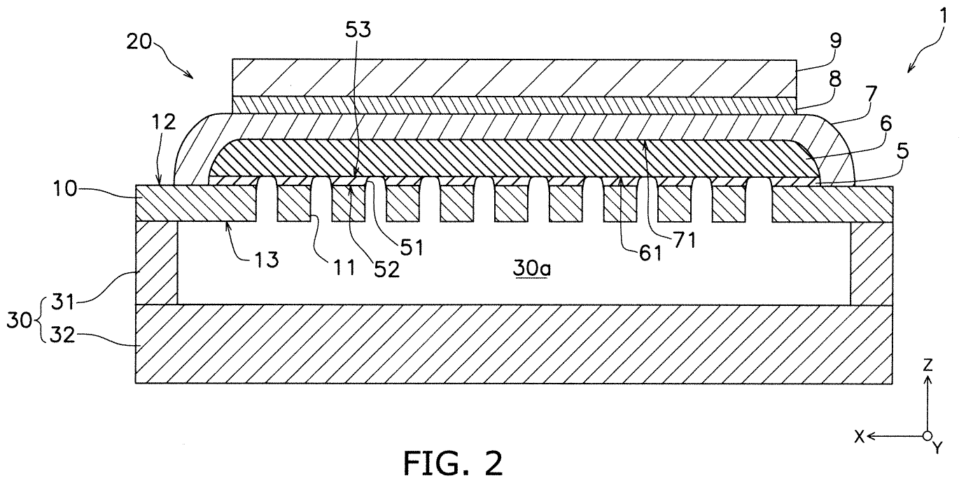

FIG. 1 is a plan view of an electrolytic cell 1 according to an embodiment. FIG. 2 is a cross-sectional view taken along line A-A in FIG. 1.

The electrolytic cell 1 is an example of an “electrochemical cell” according to the present invention. The electrolytic cell 1 is a so-called metal-supported electrolytic cell.

The electrolytic cell 1 has a plate shape extending in an X-axis direction and a Y-axis direction. In this embodiment, the electrolytic cell 1 has a rectangular shape elongated in the Y-axis direction in a plan view as viewed in a Z-axis direction perpendicular to the X-axis direction and the Y-axis direction. However, the shape of the electrolytic cell 1 in the plan view is not particularly limited and may alternatively be a polygonal shape other than a rectangular shape, an elliptic shape, a circular shape, or the like.

As shown in FIG. 2, the electrolytic cell 1 includes a metal support 10, a cell body 20, and a channel member 30.

### Metal Support 10

The metal support 10 supports the cell body 20. The metal support 10 has a plate shape. The metal support 10 may have a flat plate shape or a curved plate shape.

The metal support 10 need only be capable of supporting the cell body 20. The thickness of the metal support 10 is not particularly limited, but can be, for example, 0.1 mm or more and 2.0 mm or less.

As shown in FIG. 2, the metal support 10 has a plurality of connecting holes 11, a first principal surface 12, and a second principal surface 13.

The connecting holes 11 extend through the metal support 10 from the first principal surface 12 to the second principal surface 13 in the Z-axis direction. The connecting holes 11 are open in the first principal surface 12 and the second principal surface 13. In this embodiment, the openings of the connecting holes 11 in the first principal surface 12 are covered by the cell body 20 (specifically, a hydrogen electrode layer 6, which will be described later). The openings of the connecting holes 11 in the second principal surface 13 are continuous with a channel 30a, which will be described later.

The connecting holes 11 can be formed by means of mechanical processing (e.g., punching), laser processing, chemical processing (e.g., etching), or the like.

In this embodiment, the connecting holes 11 extend in the Z-axis direction. However, the connecting holes 11 may be inclined relative to the Z-axis direction, and need not necessarily have a straight shape. The connecting holes 11 may be continuous with each other.

The first principal surface 12 is located on a side opposite to the second principal surface 13. The cell body 20 is disposed on the first principal surface 12. The channel member 30 is joined to the second principal surface 13.

The metal support 10 is made of a metallic material. The metal support 10 is made of, for example, an alloy material containing Cr (chromium). Examples of such metallic materials include Fe-Cr alloy steel (stainless steel and the like) and Ni-Cr alloy steel. The content of Cr in the metal support 10 is not particularly limited, but can be 4 mass % or more and 30 mass % or less.

The metal support 10 may also contain Ti (titanium) and Zr (zirconium). The content of Ti in the metal support 10 is not particularly limited, but can be 0.01 mol % or more and 1.0 mol % or less. The content of Zr in the metal support 10 is not particularly limited, but can be 0.01 mol % or more and 0.4 mol % or less. The metal support 10 may contain Ti in the form of TiO₂ (titania) and may contain Zr in the form of Zro₂ (zirconia).

### Cell Body 20

The cell body 20 is disposed on the metal support 10. The cell body 20 is supported by the metal support 10. The cell body 20 has a gas diffusion layer 5, a hydrogen electrode layer 6 (cathode), an electrolyte layer 7, a reaction-preventing layer 8, and an oxygen electrode layer 9 (anode).

The gas diffusion layer 5, the hydrogen electrode layer 6, the electrolyte layer 7, the reaction-preventing layer 8, and the oxygen electrode layer 9 are stacked in this order from the metal support 10 side in the Z-axis direction. The gas diffusion layer 5, the hydrogen electrode layer 6, the electrolyte layer 7, and the oxygen electrode layer 9 are essential components, and the reaction-preventing layer 8 is an optional component.

### Gas Diffusion Layer 5

The gas diffusion layer 5 is disposed on the first principal surface 12 of the metal support 10. The gas diffusion layer 5 is interposed between the metal support 10 and the hydrogen electrode layer 6. The gas diffusion layer 5 is in direct contact with the metal support 10 and the hydrogen electrode layer 6.

The gas diffusion layer 5 has a plurality of through holes 51, a first connection surface 52, and a second connection surface 53.

The through holes 51 extend through the gas diffusion layer 5 from the first connection surface 52 to the second connection surface 53 in the Z-axis direction. The through holes 51 are open in the first connection surface 52 and the second connection surface 53. In this embodiment, the openings of the through holes 51 in the first connection surface 52 are covered by the hydrogen electrode layer 6. The openings of the through holes 51 in the second connection surface 53 are continuous with the connecting holes 11 of the metal support 10. Therefore, the gas diffusion layer 5 does not cover the connecting holes 11 of the metal support 10.

The first connection surface 52 is connected to the first principal surface 12 of the metal support 10. The first connection surface 52 is located on a side opposite to the second connection surface 53. The second connection surface 53 is connected to a metal support-side surface 61 of the hydrogen electrode layer 6.

The gas diffusion layer 5 is an electrically conductive porous body. The gas diffusion layer 5 electrically connects the metal support 10 and the hydrogen electrode layer 6. Also, a gas is supplied and discharged through the gas diffusion layer 5 between the connecting holes 11 and the hydrogen electrode layer 6. Specifically, through the gas diffusion layer 5, a source gas supplied from the connecting holes 11 is supplied to the hydrogen electrode layer 6 and a product gas produced in the hydrogen electrode layer 6 is discharged to the connecting holes 11.

The gas diffusion layer 5 contains an electrically conductive material. The gas diffusion layer 5 may include a substrate for supporting the electrically conductive material.

The electrically conductive material can be a metallic material, such as Ni (nickel) or Fe (iron), or an electrically conductive ceramic material. The substrate can be made of YSZ, CSZ, ScSZ, GDC, SDC, (La, Sr) (Cr, Mn) O₃, (La, Sr) TiO₃, Sr₂ (Fe, MO)₂O₆, (La, Sr) VO₃, (La, Sr) FeO₃, LDC (lanthanum-doped ceria), LSGM (lanthanum gallate), or a mixed material of two or more of these materials. The substrate may be insulating.

The method of forming the gas diffusion layer 5 is not particularly limited, and can be a sintering method, a spray coating method (thermal spray method, aerosol deposition method, aerosol gas deposition method, powder jet deposition method, particle jet deposition method, cold spray method, etc.), a PVD method (sputtering method, pulsed laser deposition method, etc.), a CVD method, or the like.

### Hydrogen Electrode Layer 6

The hydrogen electrode layer 6 is an example of a “first electrode layer” according to the present invention. The hydrogen electrode layer 6 is disposed on the gas diffusion layer 5. The hydrogen electrode layer 6 is sandwiched between the gas diffusion layer 5 and the electrolyte layer 7. The hydrogen electrode layer 6 has a metal support-side surface 61 that is connected to the second connection surface 53 of the gas diffusion layer 5.

The source gas is supplied to the hydrogen electrode layer 6 through the connecting holes 11 and the through holes 51. The source gas contains at least H₂O.

When the source gas contains only H₂O, the hydrogen electrode layer 6 produces H₂ from the source gas in accordance with the electrochemical reaction of water electrolysis expressed by the following chemical equation (1).

Hydrogen electrode layer 6: H₂O+2e⁻→H₂+O²⁻ (1)

When the source gas contains CO₂ in addition to H₂O, the hydrogen electrode layer 6 produces H₂, CO, and O²⁻ from the source gas in accordance with the electrochemical reaction of co-electrolysis expressed by the following chemical equations (2), (3), and (4).

Hydrogen electrode layer 6: CO₂+H₂O+4e⁻→CO+H₂+2O²⁻ (2)

Electrochemical reaction of H₂O: H₂O+2e⁻→H₂+O²⁻ (3)

Electrochemical reaction of CO₂: CO₂+2e⁻→CO+O²⁻ (4)

The hydrogen electrode layer 6 is an electrically conductive porous body. The hydrogen electrode layer 6 has gas diffusion properties. The source gas is supplied to the hydrogen electrode layer 6 from the gas diffusion layer 5. The product gas produced in the hydrogen electrode layer 6 is discharged to the channel 30a through the connecting holes 11 and the through holes 51.

The hydrogen electrode layer 6 contains an electrically conductive material. The electrically conductive material can be a metallic material, such as Ni (nickel) or Fe (iron), or an electrically conductive ceramic material. In the case of co-electrolysis, Ni also functions as a thermal catalyst to promote the thermal reaction between H₂ produced and CO₂ contained in the source gas and maintain a gas composition appropriate for methanation, reverse water-gas shift reactions, or the like.

When the electrically conductive material is constituted of a metallic material, the electrically conductive material exists in an oxide state (e.g., NiO) in an oxidizing atmosphere, and exists in a metallic state (e.g., Ni) in a reducing atmosphere. Oxidation-reduction causes a change in size of the hydrogen electrode layer 6.

The hydrogen electrode layer 6 contains an oxide ion-conductive material. The oxide ion-conductive material is an example of an “ion-conductive material” according to the present invention. The oxide ion-conductive material may be YSZ, CSZ, ScSZ, GDC, SDC, (La, Sr) (Cr, Mn) O₃, (La, Sr) TiO₃, Sr₂ (Fe, MO)₂O₆, (La, Sr) VO₃, (La, Sr) FeO₃, LDC, LSGM, or a mixed material of two or more of these materials.

In this embodiment, the hydrogen electrode layer 6 has a single layer structure constituted of a single composition, but may alternatively have a multilayer structure constituted of different compositions.

The thickness of the hydrogen electrode layer 6 is not particularly limited, but can be, for example, 1 μm or more and 500 μm or less.

The term “thickness” as used herein means the size in a thickness direction. The term “thickness direction” refers to a direction perpendicular to a surface direction parallel to a hydrogen electrode layer-side surface 71 of the electrolyte layer 7. The term “surface direction” refers to a direction parallel to an approximate straight line of the hydrogen electrode layer-side surface 71 that is obtained using the least squares method in a cross section of the electrolyte layer 7. The thickness direction may coincide with the Z-axis direction shown in FIGS. 1 and 2.

The method of forming the hydrogen electrode layer 6 is not particularly limited, and can be a sintering method, a spray coating method, a PVD method, a CVD method, or the like.

### Electrolyte Layer 7

The electrolyte layer 7 is disposed between the hydrogen electrode layer 6 and the oxygen electrode layer 9. In this embodiment, the reaction-preventing layer 8 is disposed between the electrolyte layer 7 and the oxygen electrode layer 9, and therefore, the electrolyte layer 7 is sandwiched between the hydrogen electrode layer 6 and the reaction-preventing layer 8. The electrolyte layer 7 has the hydrogen electrode layer-side surface 71 connected to the hydrogen electrode layer 6.

The electrolyte layer 7 covers the hydrogen electrode layer 6 and also covers a region of the first principal surface 12 of the metal support 10 that is exposed from the gas diffusion layer 5.

The electrolyte layer 7 transmits O²⁻ produced in the hydrogen electrode layer 6 toward the oxygen electrode layer 9. The electrolyte layer 7 is made of an oxide ion-conductive dense material. The electrolyte layer 7 can be made of, for example, YSZ (yttria stabilized zirconia; e.g., 8YSZ), GDC (gadolinium doped ceria), ScSZ (scandia stabilized zirconia), SDC (samarium solid solution ceria), LSGM (lanthanum gallate), or the like.

The porosity of the electrolyte layer 7 is not particularly limited, but can be, for example, 0.1% or more and 7% or less. The thickness of the electrolyte layer 7 is not particularly limited, but can be, for example, 1 μm or more and 100 μm or less.

The method of forming the electrolyte layer 7 is not particularly limited, and can be a sintering method, a spray coating method, a PVD method, a CVD method, or the like.

### Reaction-Preventing Layer 8

The reaction-preventing layer 8 is disposed between the electrolyte layer 7 and the oxygen electrode layer 9. The reaction-preventing layer 8 is disposed on a side opposite to the hydrogen electrode layer 6 with respect to the electrolyte layer 7. The reaction-preventing layer 8 prevents a constituent element of the electrolyte layer 7 from reacting with a constituent element of the oxygen electrode layer 9 to form a layer with high electrical resistance.

The reaction-preventing layer 8 is made of an oxide ion-conductive material. The reaction-preventing layer 8 can be made of GDC, SDC, or the like.

The porosity of the reaction-preventing layer 8 is not particularly limited, but can be, for example, 0.1% or more and 50% or less. The thickness of the reaction-preventing layer 8 is not particularly limited, but can be, for example, 1 μm or more and 50 μm or less.

The method of forming the reaction-preventing layer 8 is not particularly limited, and can be a sintering method, a spray coating method, a PVD method, a CVD method, or the like.

### Oxygen Electrode Layer 9

The oxygen electrode layer 9 is an example of a “second electrode layer” according to the present invention. The oxygen electrode layer 9 is disposed on a side opposite to the hydrogen electrode layer 6 with respect to the electrolyte layer 7. In this embodiment, the reaction-preventing layer 8 is disposed between the electrolyte layer 7 and the oxygen electrode layer 9, and therefore, the oxygen electrode layer 9 is connected to the reaction-preventing layer 8. If the reaction-preventing layer 8 is not disposed between the electrolyte layer 7 and the oxygen electrode layer 9, the oxygen electrode layer 9 is connected to the electrolyte layer 7.

The oxygen electrode layer 9 produces O₂ from O²⁻ transmitted from the hydrogen electrode layer 6 through the electrolyte layer 7, in accordance with the chemical reaction expressed by the following chemical equation (5).

Oxygen electrode layer 9: 2O²⁻→O₂+4e⁻ (5)

The oxygen electrode layer 9 is an oxide ion-conductive and electrically conductive porous body. The oxygen electrode layer 9 can be made of, for example, a composite material of an oxide ion-conductive material (e.g., GDC) and at least one of (La, Sr) (Co, Fe) O₃, (La, Sr) FeO₃, La (Ni, Fe) O₃, (La, Sr) CoO₃, and (Sm, Sr) CoO₃.

The porosity of the oxygen electrode layer 9 is not particularly limited, but can be, for example, 20% or more and 60% or less. The thickness of the oxygen electrode layer 9 is not particularly limited, but can be, for example, 1 μm or more and 100 μm or less.

The method of forming the oxygen electrode layer 9 is not particularly limited, and can be a sintering method, a spray coating method, a PVD method, a CVD method, or the like.

### Channel Member 30

The channel member 30 is joined to the second principal surface 13 of the metal support 10. The channel member 30 forms the channel 30a between the channel member 30 and the metal support 10. The source gas is supplied to the channel 30a. The source gas supplied to the channel 30a is supplied to the hydrogen electrode layer 6 of the cell body 20 through the connecting holes 11 of the metal support 10.

The channel member 30 can be made of, for example, an alloy material. The channel member 30 may be made of the same material as the metal support 10. In this case, the channel member 30 may be substantially integrated with the metal support 10.

The channel member 30 has a frame 31 and an interconnector 32. The frame 31 is an annular member that surrounds the sides of the channel 30a. The frame 31 is joined to the second principal surface 13 of the metal support 10. The interconnector 32 is a plate-shaped member for electrically connecting an external power source or another electrolytic cell to the electrolytic cell 1 in series. The interconnector 32 is joined to the frame 31.

In this embodiment, the frame 31 and the interconnector 32 are separate members, but the frame 31 and the interconnector 32 may alternatively be an integrated member.

### Specific Configuration of Gas Diffusion Layer 5

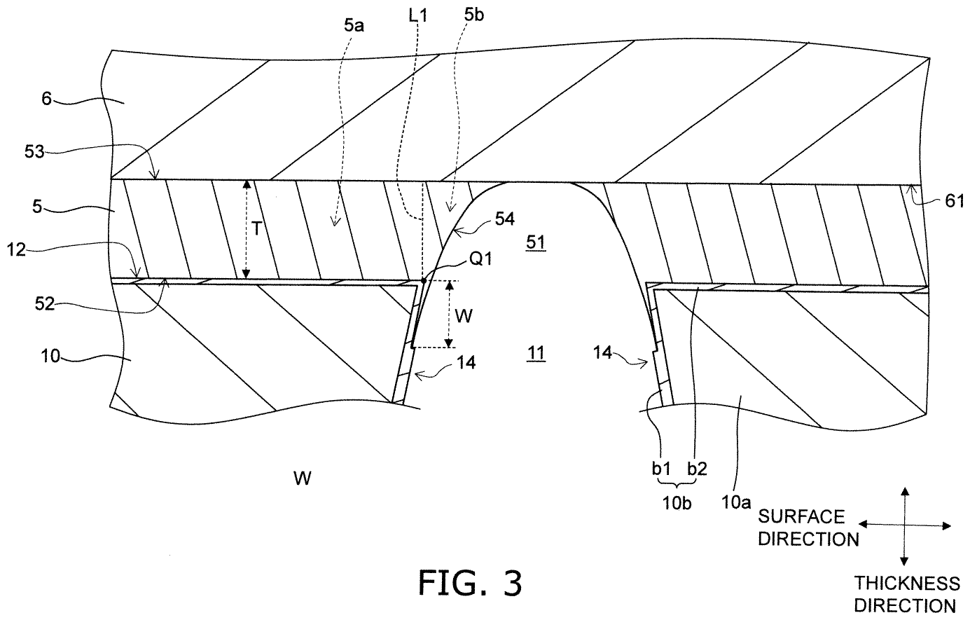

The specific configuration of the gas diffusion layer 5 will be described with reference to FIG. 3. FIG. 3 is a partially enlarged view of FIG. 2.

The gas diffusion layer 5 has a body portion 5a and protruding portions 5b.

The body portion 5a is a portion of the gas diffusion layer 5 sandwiched between the metal support 10 and the hydrogen electrode layer 6. The body portion 5a is connected to the first principal surface 12 of the metal support 10 and the metal support-side surface 61 of the hydrogen electrode layer 6.

The protruding portions 5b are continuous with the body portion 5a. The protruding portions 5b are formed in one piece with the body portion 5a. The protruding portions 5b protrude from the body portion 5a to the connecting holes 11. Each of the protruding portions 5b covers a portion of an inner circumferential surface 14 of the connecting hole 11. Specifically, the protruding portion 5b continuously covers a region near the hydrogen electrode layer 6 on the inner circumferential surface 14 of the connecting hole 11.

Distortion of the connecting hole 11 can be prevented due to the protruding portion 5b covering a portion of the inner circumferential surface 14 of the connecting hole 11 as described above, thus making it possible to prevent the gas diffusion layer 5 from being damaged (becoming cracked or peeling away). In addition, warping of the cell body 20 can also be prevented due to the distortion of the connecting hole 11 being prevented, thus making it possible to prevent the cell body 20 from becoming cracked.

Although a precise distinction need not be necessarily made, the body portion 5a and the protruding portion 5b can be distinguished based on a reference line L1. The reference line L1 is a straight line that passes through an inner end portion Q1 of the metal support 10 and is parallel with the thickness direction. When regions of the metal support 10 that face each other with the connecting hole 11 being located therebetween in the cross section taken along the thickness direction are defined as an “inner circumferential surface 14”, the inner end portion Q1 of the metal support 10 is located at a position on the inner circumferential surface 14 that is the closest to the hydrogen electrode layer 6. A portion of the gas diffusion layer 5 on a side opposite to the through hole 51 with respect to the reference line L1 is the body portion 5a, and a portion of the gas diffusion layer 5 near the through hole 51 with respect to the reference line L1 is the protruding portion 5b.

It is preferable that the protruding portion 5b tapers toward a side away from the body portion 5a in the thickness direction as shown in FIG. 3. That is to say, it is preferable that the protruding portion 5b tapers in the thickness direction as it extends in a depth direction of the connecting hole 11. This makes it possible to prevent concentration of stress at the tip of the protruding portion 5b in the thickness direction, thus making it possible to prevent the protruding portion 5b from peeling away from the inner circumferential surface 14 of the connecting hole 11.

It is preferable that the protruding portion 5b covers a portion of the metal support-side surface 61 of the hydrogen electrode layer 6 as shown in FIG. 3. As a result, the protruding portion 5b is sandwiched between the inner circumferential surface 14 of the connecting hole 11 and the metal support-side surface 61 of the hydrogen electrode layer 6, thus making it possible to improve the strength of the protruding portion 5b.

In addition, when the protruding portion 5b covers a portion of the metal support-side surface 61 of the hydrogen electrode layer 6, it is preferable that the protruding portion 5b tapers toward a side away from the body portion 5a in the surface direction as shown in FIG. 3. This makes it possible to prevent concentration of stress at the tip of the protruding portion 5b in the surface direction, thus making it possible to prevent the protruding portion 5b from peeling away from the metal support-side surface 61 of the hydrogen electrode layer 6.

Furthermore, when the protruding portion 5b covers a portion of the metal support-side surface 61 of the hydrogen electrode layer 6, it is preferable that an exposed surface 54 of the protruding portion 5b that is exposed to the connecting hole 11 and the through hole 51 is curved as shown in FIG. 3. This makes it possible to prevent local concentration of stress on the exposed surface 54, thus making it possible to prevent the exposed surface 54 from becoming cracked.

It is preferable that the ratio of a covering width w in the thickness direction of the region of the inner circumferential surface 14 of the connecting hole 11 that is covered by the protruding portion 5b to a thickness T in the thickness direction of the body portion 5a is 10 or more. With this configuration, the protruding portion 5b can further prevent the distortion of the connecting hole 11. From this viewpoint, it is particularly preferable that the covering width W is 10 μm or more.

The thickness T of the body portion 5a is calculated using the following method. First, a cross section of the gas diffusion layer 5 in the thickness direction is exposed. Next, an SEM apparatus (FE-SEM JSM-7900F, manufactured by JEOL Ltd.) is used to acquire a backscattered electron image of the cross section at a 3000-fold magnification. Next, the thickness of the body portion 5a is measured at three positions on the backscattered electron image that divide the body portion 5a into four equal sections in the surface direction. Then, the thickness T of the body portion 5a is determined by calculating the arithmetic average of the three measurement values. The thickness T of the body portion 5a can be, for example, 1 μm or more and 50 μm or less.

As shown in FIG. 3, the metal support 10 may have a substrate 10a and an oxide film 10b.

The substrate 10a is made of the above-described metallic material (e.g., Fe-Cr alloy steel or Ni-Cr alloy steel).

The oxide film 10b covers the surface of the substrate 10a. The oxide film 10b can be made of an oxide of the constituent element of the substrate 10a. A typical example of such an oxide is chromium oxide.

It is preferable that first portions b1 of the oxide film 10b that are exposed to the connecting holes 11 of the metal support 10 are thicker than a second portion b2 of the oxide film 10b that faces the hydrogen electrode layer 6. This makes it possible to improve the strength of the regions of the metal support 10 surrounding the connecting holes 11, thus making it possible to further prevent the connecting holes 11 from being distorted.

As in the case of the above-described thickness T of the gas diffusion layer 5, the thickness of each first portion b1 is determined by calculating the arithmetic average of the thicknesses measured at three positions of the first portion b1 that divide the first portion b1 into four equal sections in the thickness direction on the backscattered electron image at a 3000-fold magnification. Similarly, the thickness of the second portion b2 is determined by calculating the arithmetic average of the thicknesses measured at three positions of the second portion b2 that divide the second portion b2 into four equal sections in the surface direction on the backscattered electron image at a 3000-fold magnification.

Here, the gas diffusion layer 5 and the hydrogen electrode layer 6 have a plurality of pores thereinside. It is preferable that the average pore diameter of the pores of the gas diffusion layer 5 is smaller than the average pore diameter of the pores of the hydrogen electrode layer 6. That is to say, it is preferable that the gas diffusion layer 5 includes more small-diameter pores than the hydrogen electrode layer 6. This makes it possible to improve the gas diffusion properties of the gas diffusion layer 5, thus making it possible to make it smoother to supply a gas from the through holes 51 to the hydrogen electrode layer 6 and discharge a gas from the hydrogen electrode layer 6 to the through holes 51 through the gas diffusion layer 5.

It is preferable that the porosity of the gas diffusion layer 5 is larger than the porosity of the hydrogen electrode layer 6. That is to say, it is preferable that the volume ratio of the gas channel in the gas diffusion layer 5 is larger than the volume ratio of the gas channel in the hydrogen electrode layer 6. This makes it possible to further improve the gas diffusion properties of the gas diffusion layer 5, thus making it possible to make it much smoother to supply a gas from the through holes 51 to the hydrogen electrode layer 6 and discharge a gas from the hydrogen electrode layer 6 to the through holes 51 through the gas diffusion layer 5.

The average pore diameter and the porosity of the gas diffusion layer 5 can be acquired as follows. First, hydrogen is supplied to the gas diffusion layer 5 and the hydrogen electrode layer 6 with the temperature of the electrolytic cell 1 raised to 750° C., thereby reducing the gas diffusion layer 5 and the hydrogen electrode layer 6. Next, the temperature of the electrolytic cell 1 is lowered while maintaining the reducing atmosphere, and the electrolytic cell 1 is cut along the thickness direction to expose cross sections of the gas diffusion layer 5 and the hydrogen electrode layer 6. Next, after performing precision mechanical polishing on the cross sections, ion milling processing is performed using IM4000 manufactured by Hitachi High-Tech Corporation. Next, an SEM image in which the cross sections are enlarged is acquired using an FE-SEM (Field Emission Scanning Electron Microscope) with an in-lens secondary electron detector at a magnification that allows the pores to be recognized (e.g., 5000-fold to 30000-fold). Next, an analysis image in which portions represented in black (corresponding to the pores) on the SEM image are highlighted is acquired through image analysis using image analysis software HALCON manufactured by MVTec Software GmbH (Germany). The average pore diameter of the gas diffusion layer 5 is calculated by calculating the arithmetic average of the equivalent circular diameters of the pores (the equivalent circular diameter refers to the diameter of a circle that has the same area as the area of the pore). Next, the porosity of the gas diffusion layer 5 is calculated by dividing the total area of the pores (gas phases) by the area of the entire analysis image (solid phase).

As in the case of the gas diffusion layer 5, the average pore diameter and the porosity of the hydrogen electrode layer 6 can be calculated.

The gas diffusion layer 5 can be formed as follows. First, the substrate 10a of the metal support 10 is prepared, and a paste containing a desired oxide is applied onto the surface of the substrate 10a. In this case, the thickness of the paste applied onto the regions on the surface of the substrate 10a other than the region to be covered by the gas diffusion layer 5 may be increased. Next, pore formers corresponding to the shape of the protruding portion 5b are packed into the connecting holes 11 of the metal support 10. Next, a compact of the gas diffusion layer 5 is formed by applying a paste containing the constituent material of the gas diffusion layer 5 onto the first principal surface 12 of the metal support 10. Next, the gas diffusion layer 5 having the body portion 5a and the protruding portions 5b is formed through sintering (at 800 to 1500° C. for 1 to 5 hours) after the hydrogen electrode layer 6 is disposed on the compact of the gas diffusion layer 5.

### Variations of Embodiment

Although the embodiment of the present invention has been described above, the present invention is not limited thereto, and various changes can be made without departing from the gist of the invention.

### Variation 1

In the above embodiment, each of the connecting holes 11 of the metal support 10 tapers toward the hydrogen electrode layer 6 in the thickness direction as shown in FIG. 3. However, the cross-sectional shape of the connecting holes 11 can be changed as appropriate.

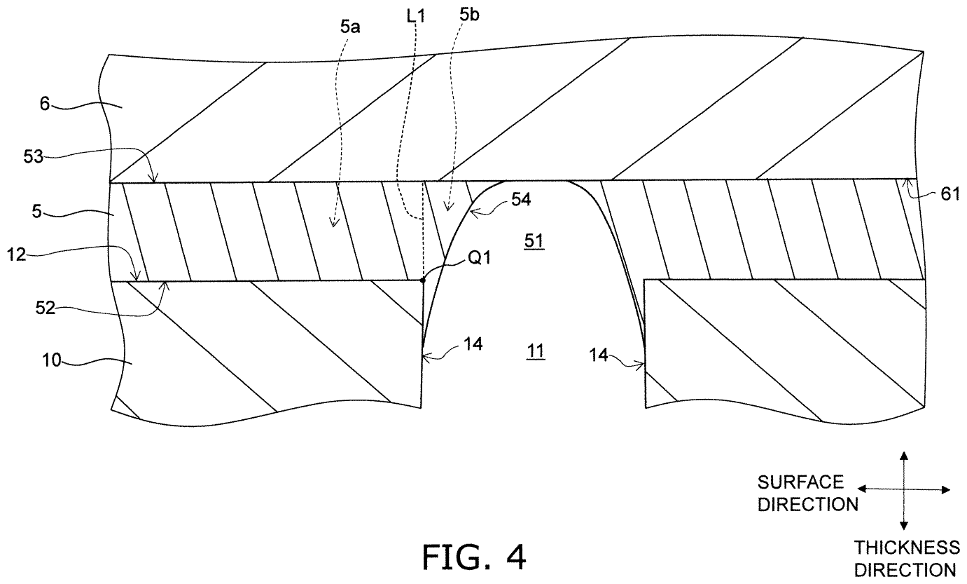

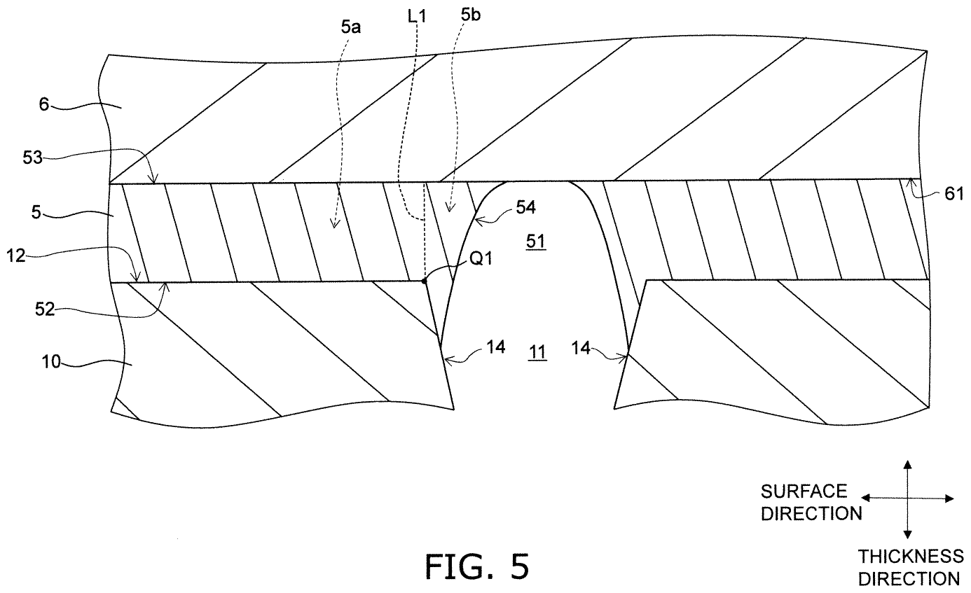

The connecting holes 11 of the metal support 10 may have a straight shape extending in the thickness direction as shown in FIG. 4 or may taper toward a side away from the hydrogen electrode layer 6 in the thickness direction as shown in FIG. 5.

### Variation 2

In the above embodiment, the electrolytic cell 1 has been described as an example of an electrochemical cell. However, the electrochemical cell is not limited to an electrolytic cell. The term “electrochemical cell” is a general term for elements in which a pair of electrodes are disposed such that electromotive force is generated from the overall redox reaction in order to convert electrical energy to chemical energy, and elements for converting chemical energy into electrical energy. Accordingly, electrochemical cells include, for example, fuel cells that use oxide ions or protons as carriers.

### REFERENCE SIGNS LIST

1 Electrolytic cell
10 Metal support
11 Connecting hole
12 First principal surface
13 Second principal surface
14 Inner circumferential surface
20 Cell body
5 Gas diffusion layer
51 Through hole
52 First connection surface
53 Second connection surface
54 Exposed surface
6 Hydrogen electrode layer
61 Metal support-side surface
7 Electrolyte layer
71 Hydrogen electrode layer-side surface
8 Reaction-preventing layer
9 Oxygen electrode layer
30 Channel member
30a Channel

1. An electrochemical cell comprising:
a metal support having a plurality of connecting holes formed in a principal surface; and
a cell body disposed on the principal surface, the cell body having:
a gas diffusion layer disposed on the principal surface;
a first electrode layer disposed on the gas diffusion layer;
a second electrode layer; and
an electrolyte layer disposed between the first electrode layer and the second electrode layer,
the gas diffusion layer having:
a body portion located in a gap between the metal support and the first electrode layer; and
a protruding portion protruding from the body portion to the connecting holes, and
the protruding portion covering a portion of an inner circumferential surface of the connecting hole.

2. The electrochemical cell according to claim 1, wherein
the protruding portion tapers toward a side away from the body portion in a thickness direction.

3. The electrochemical cell according to claim 1, wherein
the protruding portion covers a portion of a metal support-side surface of the first electrode layer.

4. The electrochemical cell according to claim 3, wherein
the protruding portion tapers toward a side away from the body portion in a surface direction perpendicular to a thickness direction.

5. The electrochemical cell according to claim 3, wherein
the gas diffusion layer includes a through hole that is continuous with the connecting hole,
the protruding portion has an exposed surface exposed to the connecting hole and the through hole, and
the exposed surface is curved.

6. The electrochemical cell according to claim 1, wherein
a ratio of a covering width in a thickness direction of a region of the inner circumferential surface of the connecting hole covered by the protruding portion to a thickness in the thickness direction of the body portion is 10 or more.

7. The electrochemical cell according to claim 1, wherein
a covering width in a thickness direction of a region of the inner circumferential surface of the connecting hole covered by the protruding portion is 10 μm or more.

8. The electrochemical cell according to claim 1, wherein
the metal support has a substrate and an oxide film covering a surface of the substrate, and
a first portion of the oxide film exposed to the connecting holes is thicker than a second portion of the oxide film covered by the protruding portion.

9. The electrochemical cell according to claim 1, wherein
an average pore diameter of multiple pores of the gas diffusion layer is smaller than an average pore diameter of multiple pores of the first electrode layer.

10. The electrochemical cell according to claim 9, wherein
a porosity of the gas diffusion layer is larger than a porosity of the first electrode layer.
